(19) United States
(12) Patent Application Publication
(10) Pub. No.: US 2012/0131372 A1
(43) Pub. Date: May 24, 2012

(54) PoE POWER SOURCING EQUIPMENT AND POWER SUPPLYING METHOD

(75) Inventor: Akihito HIBI, Nagoya-shi (JP)

(73) Assignee: Buffalo Inc., Nagoya-shi (JP)

(21) Appl. No.: 13/299,817

(22) Filed: Nov. 18, 2011

(30) Foreign Application Priority Data
Nov. 19, 2010 (JP) 2010-258848

(51) Int. Cl. G06F 1/26; G06F 11/30

(52) U.S. Cl. 713/340

(57) ABSTRACT

A Power over Ethernet (PoE) power sourcing equipment that optimizes power supplied to a PoE powered device connected to one of a plurality of power supplying ports of the PoE equipment. The Power over Ethernet (PoE) power sourcing equipment includes a plurality of power supplying ports, a consumed power monitoring unit that monitors the consumed power of the PoE powered device connected to one of the plurality of power supplying ports, and a supply power determining unit that determines the set supply power to the PoE powered device connected to the one of the power supplying ports.

### CROSS-REFERENCE TO RELATED APPLICATIONS

This application claims priority based on Japanese Patent Application No. 2010-258848 filed on Nov. 19, 2010, and its disclosures are incorporated in their entirety in this application by reference.

### BACKGROUND

1. Technical Field

This invention relates to a PoE (Power over Ethernet (registered trademark)) power sourcing equipment and power supplying method.

2. Related Art

In the past, network devices (PoE power sourcing equipment) capable of power supply compliant with the IEEE 802.3af standard regarding PoE, such as switching hubs and the like, have become widespread. PoE is technology for performing data transmission as well as supplying of power (power supply) via one LAN (Local Area Network) cable between PoE power sourcing equipment and PoE powered device. The PoE power sourcing equipment performs power classification regarding the PoE powered device connected via the LAN cable to the power supplying port (LAN port), allocates to the power supplying port supply power hierarchically set by the class corresponding to the power classifications, and supplies power to the PoE powered device.

However, with PoE power sourcing equipment compliant with the IEEE 802.3af standard, optimal power supply can not be performed. For example, with conventional PoE power sourcing equipment that is compliant with IEEE 802.3af standards, as is well known, even when the maximum consumed power of the PoE powered device connected to the power supplying port is 1 (W), the power class of that PoE powered device is classified as “Class 1,” and 3.84 (W) supply power corresponding to “Class 1” is allocated to the power supplying port to which that PoE powered device is connected. In this case, an excess of 2.84 (W), which is the difference between 3.84 (W) and 1 (W), is allocated.

Therefore, with the PoE power sourcing equipment, there is a desire to optimize the supply power to the PoE powered device connected to a plurality of power supplying ports.

### SUMMARY

One mode of the invention provides a PoE power sourcing equipment equipped with plural power supplying ports, a consumed power monitoring unit, and a supply power determining unit. The consumed power monitoring unit monitors the consumed power of the PoE powered device connected to one of the plural power supplying ports. The supply power determining unit determines the set supply power to the PoE powered device connected to the one of the power supplying port. With this PoE power sourcing equipment, it is possible to determine the supply power to the PoE powered device in more detail than with the power classification of the PoE powered device. In specific terms, with this PoE power sourcing equipment, the supply power to the PoE powered device is not limited to the hierarchically set value corresponding to the power class according to the IEEE 802.3af standard, but can be determined using any value from among continuous values. Therefore, with this PoE power sourcing equipment, it is possible to avoid allocating excess supply power as described previously, and to optimize supply power to the PoE powered device connected to the power supplying port.

With the aforementioned PoE power sourcing equipment, the consumed power monitoring unit can also monitor the consumed power for the PoE powered device for a predetermined period in time series fashion. By working in this way, the supply power determining unit can determine a suitable set supply power based on the monitored consumed power.

Moreover, the aforementioned predetermined period can be set arbitrarily. The aforementioned predetermined period, for example, can be a fixed period, or can be a period that can be set or changed by the user. With the latter, it is possible to increase convenience.

Also, various modes can be used for the timing at which the aforementioned consumed power monitoring unit and the aforementioned supply power determining unit function. As the timing at which the aforementioned consumed power monitoring unit and the aforementioned supply power determining unit function, examples include the timing at which the PoE powered device is newly connected to the aforementioned power supplying port, the timing at which the PoE powered device connected to the aforementioned power supplying port is changed, a preset cyclical timing, timing designated by the user of the PoE power sourcing equipment, timing according to a schedule preset by the user of the PoE power sourcing equipment or the like.

The aforementioned PoE power sourcing equipment may also be further equipped with a power supplying unit for performing power supply to the PoE powered device via the power supplying port, and an optimal power supply control unit for controlling the power supplying unit so that the power supplying unit supplies a set supply power to the PoE powered device. With this PoE power sourcing equipment, it is possible to do more appropriate power supply than with power supply compliant with the IEEE 802.3af standard.

The aforementioned PoE power sourcing equipment can further be equipped with a PoE power supply control unit that controls the power supplying unit so that the power supplying unit performs power sourcing in compliance with the IEEE 802.3af standard. It is also possible to have monitoring of the consumed power and determining of the set supply power be executed during control of the power supplying unit by the PoE power supply control unit, and to have the optimum power supply control unit execute control of the power supplying unit instead of the PoE power fee control unit after the set supply power has been determined. With this PoE power supply equipment, while power supply is being performed provisionally in compliance with the IEEE 802.3af standard, determination of the optimum aforementioned set supply power is performed, and after this determination, a switch is made to the optimum power supply. Therefore, even during the time waiting for optimization of the aforementioned set supply power, it is possible to perform power supply to the PoE powered device and operate it.

With the aforementioned PoE power sourcing equipment, the supply power determining unit can also determine the set supply power based on the maximum value of the monitored consumed power. For the PoE powered device to operate normally, it is necessary to supply a volume of electricity of the maximum consumed power or greater to the PoE powered device. With this PoE power sourcing equipment, for example, it is possible to determine the aforementioned power supply with more precise forecasting of the remaining power value in relation to the rated maximum consumed power of the PoE powered device than when determining the aforementioned supply power based on the average value of the aforementioned consumed power.

This invention can be realized in various modes in addition to the mode as the PoE power sourcing equipment described above, such as a power supplying method using the PoE power sourcing equipment, a computer program that realizes these, a non-transitory computer-readable storage medium on which that program is recorded, or the like. Note that for each of the modes, it is possible to apply the various additional elements shown previously.

When this invention is constituted as a computer program or a recording medium or the like on which that program is recorded, it can be constituted as an overall program for controlling the operation of the power sourcing equipment, and can also be made to constitute only the part that fulfills the functions of this invention. Also, as the recording medium, it is possible to use various media that can be read by a computer such as a flexible disk, CD-ROM, DVD-ROM, magnetic optical disk, IC card, ROM cartridge, a printed item on which a code like a barcode or the like is printed, a computer internal storage device (memory such as RAM, ROM or the like), an external storage device, or the like.

### BRIEF DESCRIPTION OF THE DRAWINGS

FIG. 1 is an explanatory drawing showing the schematic structure of the switching hub 100 as an embodiment of the PoE power sourcing equipment of this invention;

FIG. 2 is an explanatory drawing showing a power classification table compliant with the IEEE 802.3af stored in the flash ROM 20;

FIG. 3 is an explanatory drawing showing an example of time series consumed power W of the PoE powered device 200 stored in the flash ROM 20; and

FIG. 4 is a flow chart showing the flow of the power supply control process.

### DESCRIPTION OF THE PREFERRED EMBODIMENT

Following, modes of this invention are described based on embodiments.

### A. Constitution of the PoE Power Sourcing Equipment

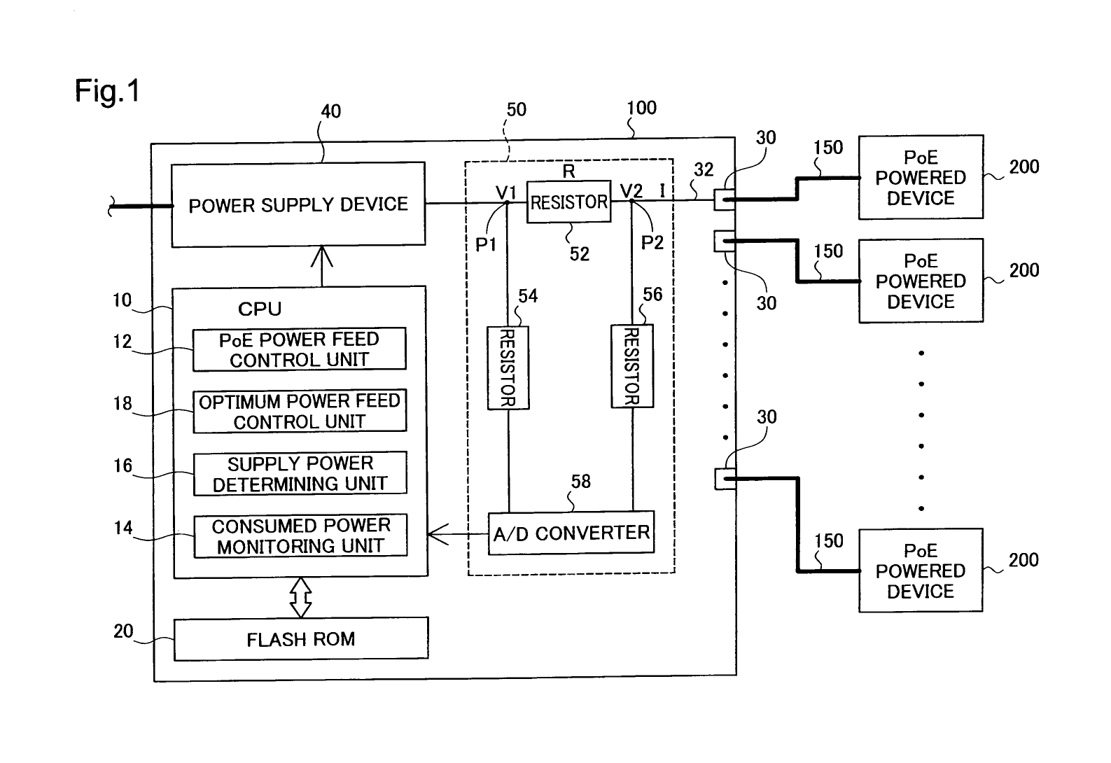

FIG. 1 is an explanatory drawing showing the schematic structure of a switching hub 100 as an embodiment of the PoE power sourcing equipment of this invention.

The switching hub 100 has a CPU 10, a flash ROM 20, a plurality of power supplying ports (LAN ports) 30, a power supply device 40, and a current detector circuit 50. The switching hub 100 is also equipped with a switching engine and transceiver (neither is illustrated) for realizing the typical functions of a switching hub. The power supply device 40 and the plurality of power supplying ports 30 can respectively have a PoE powered device 200 connected to them via a LAN cable 150.

Note that though an illustration is omitted, a current detector circuit 50 is prepared for each power line 32, and each current detector circuit 50 detects the current I that flows in the corresponding power line 32. The current detector circuit 50 is equipped with resistors 52, 54, and 56, and A/D converter 58. The A/D converter 58 fetches voltage V1 at point P1 between the power supply device 40 and the resistor 52, and voltage V2 at point P2 between the resistor 52 and the power supplying port 30, and the current I that flows in the power line 32 is calculated using the formula I=(V1−V2)/R based on these voltages V1 and V2 and the resistance value R of the resistor 52. The value of the current I is used for calculating the consumed power of the PoE powered device 200.

A CPU 10 performs overall control of the switching hub 100 such as control of the switching engine etc. by reading and executing firmware stored in the flash ROM 20. Also, the CPU 10 functions as the PoE power supply control unit 12, the consumed power monitoring unit 14, the supply power determining unit 16, and the optimal power supply control unit 18, and executes the power supply control process described later.

The PoE power supply control unit 12 controls the power supply device 40 to have it perform power supply compliant with the IEEE 802.3af standard. Specifically, the PoE power supply control unit 12 performs power classification by referencing the power classification table (described later) that is stored in the flash ROM 20 for the PoE powered devices 200 connected to the respective plurality of power supplying ports 30, allocates to the power supplying port 30 the supply power set hierarchically by class corresponding to the power classifications. The PoE power supply control unit 12 supplies power from the power supply device 40 to the PoE powered device 200.

The consumed power monitoring unit 14 monitors in time series fashion for a predetermined period of the consumed power for at least one of the PoE powered devices 200 connected to the plurality of power supplying ports 30. Specifically, the consumed power monitoring unit 14 calculates the consumed power W for the subject PoE powered device 200 based on the current I detected by the current detector circuit 50 for a predetermined period (e.g. 24 hours) at predetermined cycles (e.g 1 minute cycles). The consumed power monitoring unit 14 stores the calculated consumed power W together with the time in the flash ROM 20. With this embodiment, the power supply device 40 is a power supply device that outputs DC-48 (V) power to the power supplying port 30, so the consumed power W is calculated using the formula W=(DC-48 (V))×I.

The supply power determining unit 16 determines the set supply power Ws to the subject PoE powered device 200 based on the time-series consumed power W of the PoE powered device 200 stored in the flash ROM 20. With this embodiment, the supply power determining unit 16 determines the set supply power Ws to the PoE powered device 200 based on the maximum value (maximum consumed power Wmax) for the consumed power W monitored in time-series fashion by the consumed power monitoring unit 14.

The optimal power supply control unit 18 controls the power supply device 40 so that it supplies the set supply power Ws determined by the supply power determining unit 16 to the subject PoE powered device 200. Specifically, the optimal power supply control unit 18 allocates the set supply power Ws determined by the supply power determining unit 16 to the corresponding power supplying port 30, and has power supply done from the power supply device 40 to the PoE powered device 200.

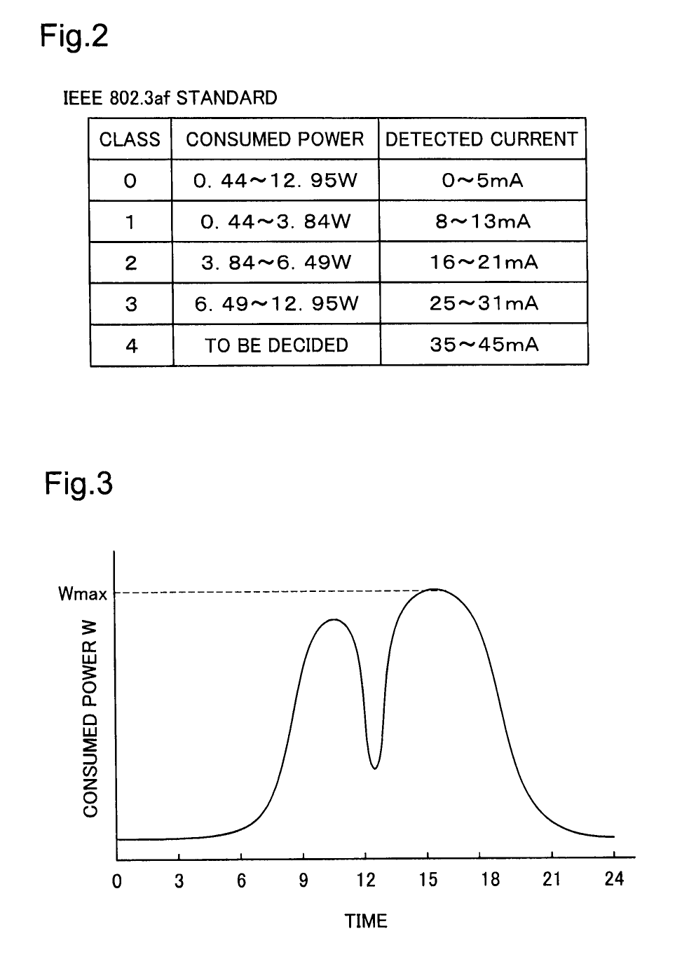

FIG. 2 is an explanatory drawing showing the power classification table compliant with the IEEE 802.3af standard stored in the flash ROM 20. As is well known, with the IEEE 802.3af standard, the PoE powered device are classified into four classes, specifically, “Class 0” to “Class 3.” Note that “Class 4” is a reserved class based on the assumption of future use.

FIG. 3 is an explanatory drawing showing an example of the time-series consumed power W of the PoE powered device 200 stored in the flash ROM 20. As shown in the drawing, with this embodiment, the consumed power monitoring unit 14 does 24-hour monitoring of the consumed power W of the PoE powered device 200. With the example in the drawing, the consumed power W is relatively low in late night and early morning, and the consumed power W is relatively high from around 9:00 to 12:00 o'clock and from around 15:00 to 18:00 o'clock. Also, around 16:00 o'clock, the consumed power W is at its maximum (maximum consumed power Wmax).

B. Power supply Control Process:

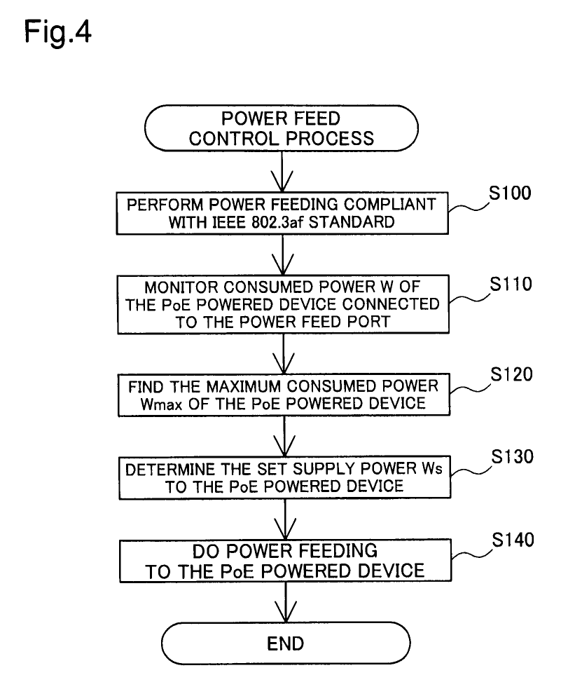

FIG. 4 is a flow chart showing the flow of the power supply control process. This power supply control process is a process executed by the CPU 10's PoE power supply control unit 12, the consumed power monitoring unit 14, the supply power determining unit 16, and the optimal power supply control unit 18 when the PoE powered device 200 is connected to the power supplying port 30.

First, the PoE power supply control unit 12 controls the power supply device 40 and has it perform power supply compliant with the IEEE 802.3af standards (step S100). Specifically, the PoE power supply control unit 12 performs power classification by referencing the power classification table regarding the PoE powered device 200 connected to the power supplying port 30, allocates to the power supplying port 30 the supply power by class corresponding to the power classifications, and has the power supply device 40 perform power supply to the PoE powered device 200. Note that power supply compliant with this IEEE 802.3af standard continues until the set supply power Ws is determined as will be described later.

When power supply compliant with the IEEE 802.3af standard is performed, the consumed power monitoring unit 14 monitors in time series fashion for a predetermined period (step S110) of the consumed power W at the PoE powered device 200 connected to the power supplying port 30. Specifically, the consumed power monitoring unit 14, as was described previously, calculates the consumed power W for example for 24 hours at 1 minute cycles based on the current I detected by the current detector circuit 50 for the PoE powered device 200 connected to the power supplying port 30. The consumed power monitoring unit 14 stores the calculated consumed power W together with the time in the flash ROM 20.

Next, the supply power determining unit 16 finds the maximum consumed power Wmax (see FIG. 3) of the PoE powered device 200 from the time-series consumed power W of the PoE powered device 200 (step S120). Also, the supply power determining unit 16 determines the set supply power Ws to the PoE powered device 200 (step S130) based on this maximum consumed power Wmax. With this embodiment, the supply power determining unit 16 calculates the set supply power Ws using the formula Ws=Wmax×M. M is a coefficient corresponding to the remaining power in relation to the rated maximum consumed power of the PoE powered device 200, and with this embodiment, M=1.1. The value of the coefficient M can be set arbitrarily.

The optimal power supply control unit 18, after the set supply power Ws is determined, executes control of the power supply device 40 instead of the PoE power supply control unit 12. The optimal power supply control unit 18 controls the power supply device 40, and has it supply power of the set supply power Ws determined at step S130 from the power supply device 40 to the PoE powered device 200 (step S140).

With the switching hub 100 of this embodiment described above, while power supply compliant with the IEEE 802.3af standard is performed provisionally, the set supply power Ws to the PoE powered device 200 is determined, after which power supply according to the set supply power Ws is performed. With the power supply compliant with the IEEE 802.3af standard, power supply is performed with supply power by class hierarchically set corresponding to the power class. Meanwhile, when determining the set supply power Ws, this is not limited to a preset hierarchical value, and it is possible to use any value from among continuous values, making more detailed supply power setting possible. Therefore, with the switching hub 100 of this embodiment, the allocation of excess supply power described previously is avoided, and it is possible to optimize the supply power to the PoE powered device 200 connected to the power supplying port 30.

### C. Variations:

Above, modes of carrying out this invention are described, but this invention is not limited to this kind of mode of embodiment, and it is possible to implement various modes within a scope that does not stray from its gist. For example, the following kinds of variations are possible.

### C1. Variation 1:

With the embodiments noted above, with the power supply control process, the predetermined period for the consumed power monitoring unit 14 to monitor the consumed power W of the PoE powered device 200 connected to the power supplying port 30 is 24 hours, but the predetermined period for which monitoring is performed is not limited to this, and can be set arbitrarily. The aforementioned predetermined period can also be set to another fixed time such as 1 week or the like, for example. Also, the aforementioned predetermined period can be made such that it can be set or changed by the user. Having the aforementioned predetermined period made to be able to be set or changed by the user increases convenience for the user. This is the same for the cycle for fetching the consumed power W of the PoE powered device 200.

Also, the period for monitoring the consumed power W of the PoE powered device 200 connected to the power supplying port 30 does not have to be a period determined in advance before starting monitoring. Specifically, it is also possible to set the period for monitoring the consumed power W of the PoE powered device 200 based on the value of the obtained consumed power or the manner of fluctuation of the obtained consumed power or the like after monitoring has started. Also, monitoring of the consumed power W of the PoE powered device 200 does not have to be performed for predetermined periods continuously, but can also be executed by performing sampling a plurality of times with intervals left open. This sampling interval can be a constant interval, or on the other hand, it can also be an interval set based on the obtained consumed power value or the manner of fluctuation of the obtained consumed power or the like after monitoring has started. Specifically, monitoring of the consumed power W of the PoE powered device 200 connected to the power supplying port 30 can be performed in any mode. Note that as the monitoring mode, it is possible to use a mode for which this is performed for each power supplying port based on the same conditions for each power supplying port.

### C2. Variation 2:

With the embodiments noted above, the CPU 10 performs power supply control processing when the PoE powered device 200 is connected to the power supplying port 30, but the power supply control processing start timing is not limited to this. The power supply control processing start timing can also be the timing when the PoE powered device 200 connected to the power supplying port 30 is changed, for example. Also, the processing with power supply control process of step S110 and thereafter can be made to be performed at various timings. The start timing of the processing of step S110 and thereafter can be, for example, a preset cyclical timing, a timing indicated by the user, a timing according to schedule preset by the user or the like.

### C3. Variation 3:

With the embodiments noted above, the supply power determining unit 16 determines the set supply power Ws based on the maximum consumed power Wmax for the time-series consumed power W of the PoE powered device 200 with the power supply control process, but the method for setting the set supply power Ws is not limited to this. For example, it is also possible to set the set supply power Ws based on the average value (average consumed power) for the time-series consumed power W of the PoE powered device 200. However, as with the embodiments noted above, if the set supply power Ws is set based on the maximum consumed power Wmax, it is possible to set the set supply power Ws with a more accurate forecast of the remaining power value in relation to the rated maximum consumed power of the PoE powered device 200 than in the case of setting the set supply power Ws based on the average value for the consumed power W.

Also, with the embodiments noted above, the coefficient M used when setting the set supply power Ws considering the remaining power based on the maximum consumed power Wmax is 1.1. However, the coefficient used when setting the set supply power considering the remaining power based on the maximum consumed power can be any value. For example, the value of that coefficient may be 1 or greater.

### C4. Variation 4:

With the embodiments noted above, the switching hub 100 monitors the consumed power W of the PoE powered device 200 connected to the power supplying port 30 using the current detector circuit 50, but the method of monitoring the consumed power W is not limited to this. To monitor the consumed power W of the PoE powered device 200 connected to the power supplying port 30, instead of the current detector circuit 50, it is also possible to use a means having another constitution that is able to obtain this through measurement or calculation of the value of the current flowing to the power supplying port 30.

### C5. Variation 5:

With the embodiments noted above, first, the PoE power supply control unit 12 performs power supply compliant with the IEEE 802.3af standard, and after that, the optimal power supply control unit 18 performs power supply according to the set supply power Ws. Switching from control by the PoE power supply control unit to control by the optimum power supply control unit can be realized using control by the optimum power supply control unit as the trigger, or it can be realized with control by a constitution other than the optimum power supply control unit such as the supply power determining unit as the trigger. For example, it is possible to equip a constitution for judging the switching period from control by the PoE power supply control unit to control by the optimum power supply control unit and executing the switch that is separate from the PoE power supply control unit, the supply power determining unit, the optimum power supply control unit and the like mentioned in this specification.

### C6. Variation 6:

With the embodiments noted above, for the supply power to the PoE powered device, any value from among continuous values can be used. However, the supply power to the PoE powered device can also be selected from among discrete values. The supply power to the PoE powered device can be selected from among a larger number of candidate values than the number of power classes according to the IEEE 802.3af standard. With such a mode, for example the supply power to the PoE powered device may be selected from among four or more candidate values, and may be selected from among five or more candidate values. Note that with this specification, as a mode for which “it is possible to continuously set the value of the set supply power,” the following two modes are included. The first mode is a mode with which it is possible to set analog continuous values arbitrarily as the set supply power. The second mode is a mode with which a large number of discrete values are prepared as choices of the set supply power to the degree that it is possible to substantially regard them as continuous values.

### C7. Variation 7:

With the embodiments noted above, a case when the PoE power sourcing equipment of this invention was applied to a switching hub is described, but this invention can be applied to other network devices equipped with a power supplying port, such as a so-called PoE splitter, a PoE indicator or the like.

### C8. Variation 8:

With the switching hub 100 of the embodiments noted above, a portion of the constitutions realized using software can be replaced with hardware, and conversely, a portion of the constitution realized using hardware can also be replaced using software.

1. A PoE (Power over Ethernet®) power sourcing equipment, comprising:
a plurality of power supplying ports; and
a first processor that monitors consumed power of a PoE powered device connected to one of the plurality of power supplying ports; and
a second processor that determines a set supply power to the PoE powered device connected to the one of the plurality of power supplying ports based on the monitored consumed power.

2. The PoE power sourcing equipment according to claim 1, wherein the first processor monitors the consumed power of the PoE powered device in time series fashion for a predetermined period.

3. The PoE power sourcing equipment according to claim 1 further comprising:
a power supplying device that supplies power to the PoE powered device via the one of the plurality of power supplying ports; and
a third processor that controls the power supplying device so that the power supplying device supplies the set supply power to the PoE powered device.

4. The PoE power sourcing equipment according to claim 3, further comprising;
a fourth processor that controls the power supplying device so that the power supplying device supplies power compliant with the IEEE 802.3af standard, wherein
the monitoring of the consumed power and the determining of the set supply power are executed during control of the power supplying device by the fourth processor compliant with the standard , and
after the set power supply is determined, the third processor executes control of the power supplying device according to the set supply power instead of compliant with the standard

5. The PoE power sourcing equipment according to claim 1, wherein
the second processor determines the set supply power based on a maximum value of the monitored consumed power.

6. A power supplying method using a PoE (Power over Ethernet®) power sourcing equipment having a plurality of power supplying ports, the method comprising:
monitoring consumed power of a PoE powered device connected to one of the plurality of power supplying ports; and
determining set supply power to the PoE powered device connected to the one of the plurality of power supplying port based on the monitored consumed power.

7. The power supplying method according to claim 6, wherein the monitoring includes monitoring the consumed power of the PoE powered device in time series fashion for a predetermined period.

8. The power supplying method according to claim 6, further comprising:
supplying power to the PoE powered device via the one of the plurality of power supplying ports; and
controlling the power supply so that the set supply power is supplied to the PoE powered device.

9. The power supplying method according to claim 8, further comprising:
controlling the power supply to supply power compliant with the IEEE 802.3af standard, wherein
the monitoring and the determining are executed during the control of the power supply compliant with the standard, and
after the set supply power is determined, the control of the power supply is executed according to the set supply power instead of control of the power supply compliant with the standard.

10. The power supplying method according to claim 6, wherein the determining is executed based on a maximum value of the monitored consumed power.

11. A non-transitory computer-readable medium including computer-program instructions, which when executed by a PoE (Power over Ethernet ®) power sourcing equipment having a plurality of power supplying ports, causes the PoE power sourcing equipment to perform a power supplying method comprising:
monitoring consumed power of a PoE powered device connected to one of the plurality of power supplying ports; and
determining set supply power to the PoE powered device connected to the one of the plurality of power supplying port based on the monitored consumed power.

12. The non-transitory computer-readable medium according to claim 11, wherein the monitoring includes monitoring the consumed power of the PoE powered device in time series fashion for a predetermined period.

13. The non-transitory computer-readable medium according to claim 11, further comprising:
supplying power to the PoE powered device via the one of the plurality of power supplying ports; and
controlling the power supply so that the set supply power is supplied to the PoE powered device.

14. The non-transitory computer-readable medium according to claim 13, further comprising:
controlling the power supply to supply power compliant with the IEEE 802.3af standard, wherein
the monitoring and the determining are executed during the control of the power supply compliant with the standard, and
after the set supply power is determined, the control of the power supply is executed according to the set supply power instead of control of the power supply compliant with the standard.

15. The non-transitory computer-readable medium according to claim 11, wherein the determining is executed based on a maximum value of the monitored consumed power.
